(19) United States
(12) Patent Application Publication
(10) Pub. No.: US 2008/0315533 A1
(43) Pub. Date: Dec. 25, 2008

(54) INFLATABLE SEALING DEVICE FOR A MOLDING TOOL

(75) Inventor: RAINER JANOTTA, Bissendorf (DE)

Correspondence Address: Henry M. Feiereisen;Henry M. Feiereisen, LLC, Suite 1501, 708 Third Avenue, New York, NY, 10017, US

(73) Assignee: KraussMaffei Technologies GmbH, Munchen (DE)

(21) Appl. No.: 12/196,676

(22) Filed: Aug. 22, 2008

Related U.S. Application Data
(63) Continuation of application No. PCT/EP2007/051498, filed on Feb. 16, 2007.

(30) Foreign Application Priority Data
Apr. 1, 2006 (DE) 10 2006 015 184.4

(51) Int. Cl. F16J 15/46

(52) U.S. Cl. 277/646

(57) ABSTRACT

An inflatable sealing device includes a bushing and a plunger which is movably guided in the bushing through application of air pressure from an air supply to execute a predefined limited stroke. A sealing tube is connected to the plunger and has an interior space which is connected to the air supply to radially expand the sealing tube when air pressure is applied.

### CROSS-REFERENCES TO RELATED APPLICATIONS

This application is a continuation of prior filed copending PCT International application no. PCT/EP2007/051498, filed Feb. 16, 2007, which designated the United States and has been published but not in English as International Publication No. WO 2007/113042 and on which priority is claimed under 35 U.S.C. §120, and which claims the priority of German Patent Application, Serial No. 10 2006 015 184.4, filed Apr. 1, 2006, pursuant to 35 U.S.C. 119(a)-(d), the contents of which are incorporated herein by reference in its entirety as if fully set forth herein.

### BACKGROUND OF THE INVENTION

The present invention relates, in general, to an inflatable sealing device for a molding tool.

Nothing in the following discussion of the state of the art is to be construed as an admission of prior art.

The production of coated plastic products, in particular of foamed sandwich plastic products with a polyurethane material core, involves a production process in which insert material (insert), which forms the outer skin for example, is placed in a cavity as well as a skin, which possibly forms the inner surface. Placed into the cavity between the insert, which may involve, e.g., a deep-drawn film or a metal part such as an aluminum element etc., and the skin is plastic material, for example a foam material, such as polyurethane material which cures as thermosetting or thermoplastic material. In this way, a sandwich product is formed after curing which is composed of several layers; According to the above-stated example, this means an insert layer forming the outer skin, a polyurethane layer forming the core, and a skin layer forming the inner side.

As the interstices between the insert and the skin is filled, no foam material should escape between insert and skin to the surroundings, especially in the marginal area of the product being made, when a certain pressure builds up in the foam material. An inflatable sealing tube can hereby be used which is placed in a half-mold on the parting surface side, causing a desired sealing between skin and insert, as the sealing tube presses against the skin and in turn the skin against the insert. The degree of sealing is defined by the applied air pressure. Preferably, a sealing device should, of course, extend over the entire circumference of the cavity in order to ensure the sealing action throughout.

It would be desirable and advantageous to provide an improved inflatable sealing device to obviate prior art shortcomings and to ensure a sealing up to precisely predefined ends so that even narrow transitions can be sealed, while allowing simple installation into the molding tool so as to eliminate the need for producing separate molding parts.

### SUMMARY OF THE INVENTION

According to one aspect of the present invention, an inflatable sealing device includes a bushing, a plunger movably guided in the bushing through application of air pressure from an air supply to execute a predefined limited stroke, and a sealing tube connected to the plunger and having an interior space connected to the air supply to expand the sealing tube when air pressure is applied.

The arrangement of the combination of sealing tube and plunger with limited stroke ensures a simple sealing up to a precisely defined end of the sealing device because the sealing in the form of the tube and the extendible plunger is “inflatable’ up to the defined end. As a result, also tight transitions can be reliably sealed. Moreover, a standardized round tube may be used as element for the sealing so that no excessive costs incur. The limited stroke of the extendible plunger prevents damage to skin and insert, on one hand, and ensures that the integrity of the inflatable sealing device cannot fall apart, when the molding tool is open.

The stroke limitation may be realized by arranging on the outer circumference of the plunger a groove or a recess in which an engagement part of the bushing projects, with the groove or the recess as well as the engagement part dimensioned to constructively establish the limited stroke. Of course, the construction may also be realized with exchanged elements, i.e. the bushing has an inner circumference provided with a groove into which an engagement part of the plunger projects or engages. It is only essential that the interaction of recess/groove and engagement part result sin a stop for the movement of the plunger.

A simple construction for producing the engagement part, arranged on the bushing, may involve a retaining or Seger ring which is firmly received in an inner groove of the bushing.

To ensure the tightness, a separate seal may be arranged between the plunger and the bushing. An O-ring may be provided for example which is inserted in a groove either of the plunger or the bushing.

To avoid damage to the skin, the head area of the plunger may be provided with a plastic covering or a plastic cap, alternatively also with rubber or respectively soft material.

To prevent the sealing tube from collapsing, a filler cord may be arranged in its interior space and may have a cross section configured in the shape of a star.

For flow dynamics, a channel may be provided in the plunger to establish a flow connection with a blind bore in which the sealing tube is inserted. The other end of the channel may be configured with an inlet which narrows in flow direction. As a result of such a narrowing, for example conically shaped inlet, the force is determined in dependence on the applied air pressure for pushing the plunger upwardly and for pressing the skin against the insert.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a greatly schematized sectional illustration of a closed molding tool with insert, skin and foam material, with the end between insert and skin being sealed by means of a sealing device according to the invention;

FIG. 2 is a schematic side view of a first embodiment of a sealing device according to the invention which is removed from the molding tool;

FIG. 3 is an exploded drawing of the inflatable sealing device according to FIG. 2;

FIG. 4 is a cross section through the sealing tube with filler cord;

FIG. 5 is a perspective illustration of a bushing for the sealing device of FIG. 2 in accordance with the invention;

FIG. 6 is a perspective illustration of a plunger for the sealing device of FIG. 2 in accordance with the invention;

FIG. 7 is a schematic illustration of the air channels in the plunger of the sealing device according to with the invention;

FIG. 8 is two sealingly interacting inventive sealing devices according to FIG. 2 in side-by-side relationship;

FIG. 9a is an exploded drawing of a second embodiment of an inflatable sealing device according to the invention;

FIG. 9b is a schematic illustration of a sealing device according to FIG. 9a in assembled state;

FIG. 10 is a detailed illustration of a milling contour for a seal of a sealing device according to FIG. 9a; and

FIG. 11 is a schematic sectional illustration of a sealing device according to FIG. 9a in assembled state.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

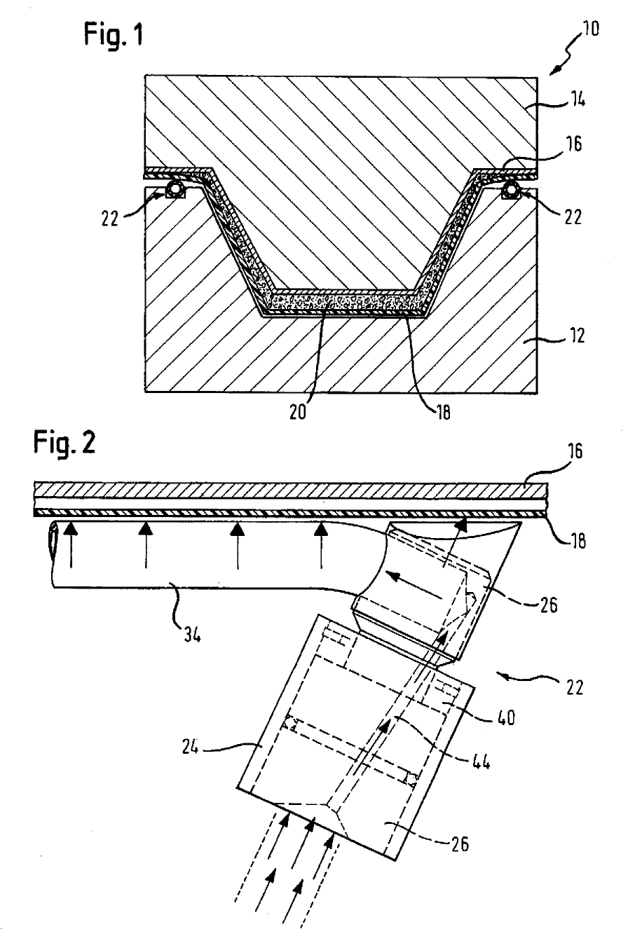

Turning now to the drawing, and in particular to FIG. 1, there is shown a greatly schematized sectional illustration of a closed molding tool 10 to show the operation of a sealing device according to the invention, generally designated by reference numeral 22. The molding tool 10 includes a bottom half-mold 12 and a top half-mold 14, which are depicted in closed state and define a mold cavity between them. Placed in this mold cavity is, on one hand, an insert 16 which bears upon the top half-mold 14, and a skin 18 which bears upon the cavity surface of the bottom half-mold 12. Introduced between the insert 16 and the skin 18 is a polyurethane material which cures so as to produce overall after curing a sandwich product comprised of insert, polyurethane core and skin.

To prevent escape of plastic or liquid polyurethane material before curing, the sealing device 22 is arranged in the marginal area of the foaming mold, shown in FIG. 1 only by the section through a sealing tube. The sealing device 22 is received in a groove or recess of the bottom half-mold 12 and embraces the cavity essentially entirely in the parting plane between the half-molds 12, 14.

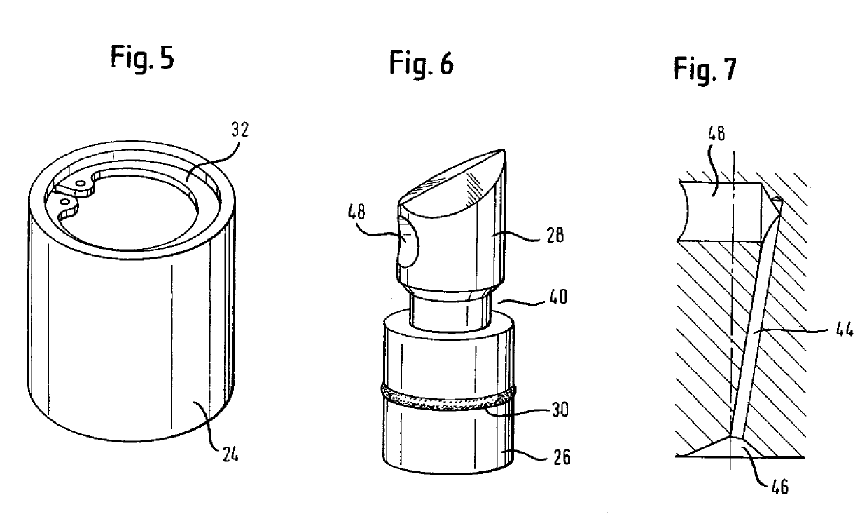

The details of the inflatable sealing device 22 can be seen in FIGS. 2 to 7. All Figures show a shortened round sealing tube 34. The round sealing tube 34 may be designed much longer in the actual embodiment.

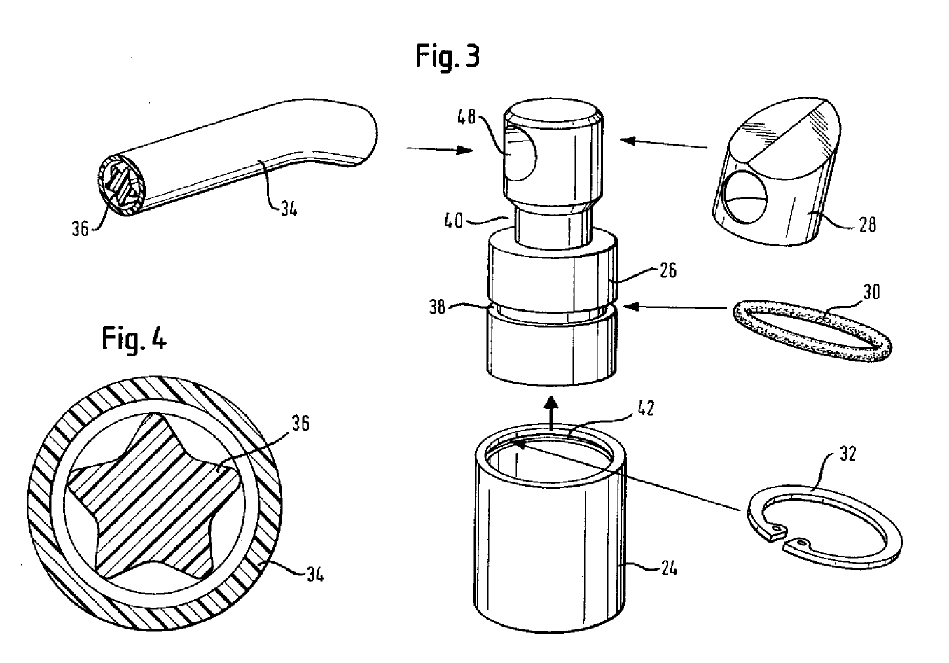

The sealing device 22 includes a bushing 24 or sleeve which receives a plunger 26, e.g. made of brass, which has a limited stroke to move back and forth. The round sealing tube 34 is connected to the head zone of the plunger 26 and is inflatable, as will be described hereinafter. As shown in detail in FIGS. 3, 5, and 6, the bushing 24 has an inner groove in which a Seger ring 32 is firmly seated. The plunger 26 includes on the other side in midsection a stepped ring-shaped groove 40 or recess. The head zone of the plunger extends above the stepped groove 40. Arranged below the stepped groove 40 is an essentially cylindrical part of the plunger which includes essentially in midsection a further more shallow annular groove 38. An O-ring is inserted in this annular groove 38.

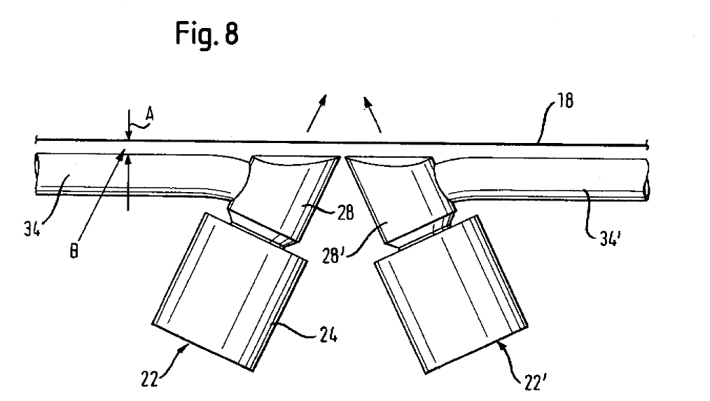

When the plunger 26 and the bushing 24 are assembled together, the Seger ring 32 extends into the region of the stepped groove 40, with a stop being formed by the cylindrical lower part of the plunger 26 in combination with the Seger ring 32 for preventing an excessive upward displacement of the plunger 26 out of the bushing 24 and thus limiting the stroke. The stroke limitation is indicated i.a. in FIG. 8 by the characters A and B and may be selected for example in the range of 5 mm.

The plunger 26 has in this way a mobility of about 5 mm. Formed in the head zone of the plunger is a blind bore 48, as can be seen in FIG. 7. Received in this blind bore 48 is an open end of the round sealing tube 34.

The bore 48 is fluidly connected with a further bore which defines an air channel 44 and is provided in the plunger 26 in a manner shown in FIG. 7. At the end opposite to the blind bore 48, the air channel 44 respectively ports into a conical expansion 46 or constriction, as viewed in flow direction. This conical expansion 46 is thus formed in the present case on the lower end of the plunger.

When assembled, a plastic covering 28 is arranged around the head of the plunger 26. Moreover, the interior of the round sealing tube 34 accommodates a filler cord 36 which—as can be seen in FIG. 4—has a substantially star-shaped cross section.

The mode of operation of the present inflatable sealing device 22 can be seen from FIG. 2. When air under a predefined pressure is supplied from below to the plunger 26, the conically designed constriction 46 fluidly acts in such a manner that the plunger 26 is pushed upwards in dependence on the air pressure and presses the skin 18 with its plastic cover 28 against the insert 16. The plastic cap or a respective coating of the head part of the plunger 26 prevents damage to the skin 18. Air flows via the channel 44 and the blind bore 48 into the interior of the round sealing tube 34 which radially expands in accordance with the air pressure and thereby also presses the skin 18 against the insert 16. Overall, a linear sealing can be established up to a very sharp limitation, with the limitation being defined on the one side by the limited contact area of the end of the plunger 26 and on the other side by the tube end.

By placing—as shown in FIG. 8—two respective sealing devices 22 and 22′ next to one another, a sealing transition between two sealing devices can be established almost seamlessly because both plungers 28 and 28′ press the skin 18 upon the insert 16 when aligned immediately next to one another. In the further course of action, the skin 18 is pressed upon the insert 16 by the two round sealing tubes 34, 34′. The bushing may hereby be configured also as part of the tool. It thus does not necessarily have to be provided as separate structure.

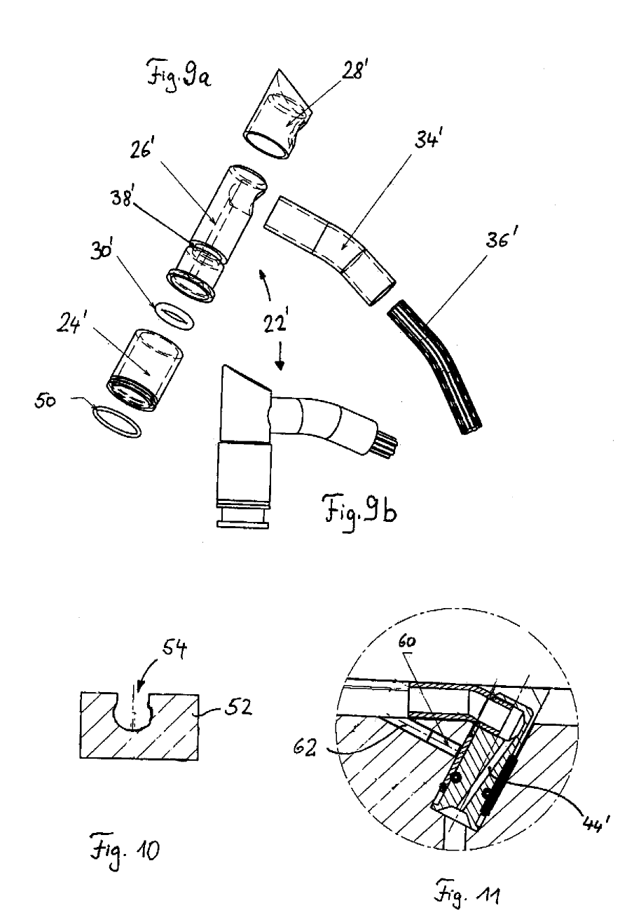

FIGS. 9a to 11 show a further embodiment of a sealing device according to the invention. In the following description, parts corresponding with those in FIGS. 2-8 will be identified by corresponding reference numerals, followed by a “ ”.

A sealing device 22′ according to the invention includes again a bushing 24′ or sleeve which receives a plunger 26′ with limited stroke for back-and-forth movement. The round sealing tube 34′ is connected in the head zone with the plunger 26′ which is inflatable, as will be described hereinafter.

The plunger 26′ includes a lower stop flange which impacts against the bushing 24′ in the upper end position, when assembled. Arranged above the stop flange is an essentially cylindrical part of the plunger 26′ in which a further more shallow annular groove 38′ is arranged essentially in midsection. An O-ring 30′ is seated in its annular groove 38.

Further arranged in the lower area of the bushing 24′ is a sealing recess 54 for receiving an O ring seal 50 which has a contour as shown in FIG. 10 which shows only a bushing portion 52. The O ring seal 50 seals the bushing 24′ against the molding tool, when installed.

After assembly of plunger 26′ and bushing 24′, the sealing device 22′ is placed into the respective recess of the tool (cf. FIG. 11). The tool has a bore 62 with internal thread in the area of the bushing receptacle for threaded engagement of a stud screw 60. After insertion of the sealing device 22′, the bushing 24′ can be secured by means of the stud screw, thereby enabling a wanted positioning of the bushing 24′ in its axial direction.

The plunger 26′ cam only move in a defined region in the bushing 24′, with a stop for the plunger being established by the tool and a stop being established by the lower end of the bushing 24′. The stop flange of the plunger 26′ bears respectively against these stops. The plunger 26′ of the sealing device 22′ may move more or less upwardly depending on the adjustment of the bushing 24′.

As a consequence of the construction of the screw fastening of the bushing 24′, the entire sealing device 22′ mat be exchanged rapidly and easily; There is no need for a special tool and moreover the safety construction does not require much space.

The stroke limitation may again be selected in the range of 5 mm. The plunger 26′ has in this way again a mobility of about 5 mm. Like in the first embodiment, the head zone of the plunger is formed with a blind bore. Received in this blind bore 48 is an open end of the round sealing tube 34′.

The blind bore is fluidly connected with a further bore which defines an air channel 44′ and is provided in the plunger 26′. At the end opposite to the blind bore 48, the air channel 44′ respectively ports into a conical expansion or a constriction, as viewed in flow direction. This conical expansion is thus formed in the present case on the lower end of the plunger 26′.

When assembled, a plastic covering 28′ is arranged around the head of the plunger 26′. Moreover, the interior of the round sealing tube 34′ accommodates a filler cord 36′ which again has a substantially star-shaped cross section.

The mode of operation of the inflatable sealing device 22′ can be seen FIG. 11. When air under a predefined pressure is supplied from below to the plunger 26′, the conically designed constriction fluidly acts in such a manner that the plunger 26′ is pushed upwards in dependence on the air pressure and presses the skin 18 with its plastic covering 28′ against the insert. As a consequence of the plastic cap or a respective coating of the head part of the plunger 26′, damage to the skin is prevented. Air flows via the channel 44′ and the blind bore into the interior of the round sealing tube 34′ which radially expands in accordance with the air pressure and thereby also presses the skin against the insert. Overall, a linear sealing can be established up to a very sharp limitation, with the limitation being defined on the one side by the limited contact area of the end of the plunger 26′ and on the other side by the tube end.

In summary, the sealing device according to the invention ensures a reliable sealing up to the defined ends of the sealing device in an inflatable manner, whereby even tight transitions can be sealed. The use of a standardized round tube as seal in the sealing device has a cost-saving effect. Moreover, the plunger cannot disintegrate as a result of the stroke limitation and cannot move upwards in an unwanted manner.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. An inflatable sealing device, comprising:
a bushing;
a plunger movably guided in the bushing through application of air pressure from an air supply to execute a stroke, wherein one member selected from the group consisting of plunger and bushing has a groove, and the other member of the group has an engagement part for engagement in the groove to thereby provide a stop to limit the stroke of the plunger; and
a sealing tube connected to the plunger and having an interior space connected to the air supply to expand the sealing tube when air pressure is applied.

2. The inflatable sealing device of claim 1, wherein the plunger has an outer circumference formed with the groove for engagement of the engagement part of the bushing, wherein the groove and the engagement part are dimensioned to establish the limited stroke.

3. The inflatable sealing device of claim 1, wherein the plunger has an outer circumference formed with the engagement part for engagement into the groove of the bushing, wherein the groove and the engagement part are dimensioned to establish the limited stroke.

4. The inflatable sealing device of claim 2, wherein the engagement part is a retaining ring or a Seger ring which is received in an inner groove of the bushing.

5. The inflatable sealing device of claim 1, wherein the bushing is held in place in a molding tool by a detachable screw received in a bore of the molding tool and bearing against the bushing.

6. The inflatable sealing device of claim 5, wherein the screw is a stud screw.

7. The inflatable sealing device of claim 1, wherein the plunger has an outer circumference formed with a groove for accommodating a sealing member to provide a seal between the plunger and the bushing.

8. The inflatable sealing device of claim 7, wherein the sealing member is an O ring.

9. The inflatable sealing device of claim 1, wherein the bushing has an inner circumference formed with a groove for accommodating a sealing member to provide a seal between the plunger and the bushing.

10. The inflatable sealing device of claim 9, wherein the sealing member is an O ring.

11. The inflatable sealing device of claim 1, wherein the plunger has a head part intended to provide a seal and to press against an insert part of a molding tool, said head part being covered by a member selected from the group consisting of plastic covering, plastic cap, rubber covering, and covering of elastic material.

12. The inflatable sealing device of claim 1, further comprising a filler cord arranged in the interior space of the sealing tube.

13. The inflatable sealing device of claim 1, wherein the filler cord has a star-shaped cross section.

14. The inflatable sealing device of claim 1, wherein the plunger is formed with a blind bore for insertion of one end of the sealing tube, and a channel in flow connection with the blind bore and communicating with the air supply.

15. The inflatable sealing device of claim 14, wherein the channel has one end which is distal to the blind bore and formed to provide an inlet which narrows in flow direction.

16. The inflatable sealing device of claim 15, wherein the inlet has a conical shape.
